(19) United States
(12) Patent Application Publication
(10) Pub. No.: US 2026/0226893 A1
(43) Pub. Date: Aug. 6, 2026

(54) Pressure Device

(71) Applicant: Great Southern Motor Company Pty. Ltd., Brendale QLD (AU)

(72) Inventor: Derek Auret, Kirwan QLD (AU)

(21) Appl. No.: 19/145,155

(22) PCT Filed: Dec. 21, 2023
(86) PCT No.: PCT/AU2023/051351

§ 371 Date: Jul. 1, 2025

(30) Foreign Application Priority Data
Jan. 21, 2023 (AU) 2023900140

(51) Int. Cl. F04B 53/16; F04B 19/24; F17C 1/12; F17C 13/04

(52) U.S. Cl. CPC F04B 53/162; F04B 19/24; F17C 1/12; F17C 13/04; F17C 2221/012; F17C 2221/038

(57) ABSTRACT

A vessel for use in a compressor including at least one wall that defines an enclosed internal area defining a fixed volume and being configured to hold a gas; at least one entry port in the wall for introducing gas into the enclosed internal area of the vessel; at least one exit port in the wall for releasing gas from the enclosed internal area of the vessel; at least one heating element located in the enclosed internal area; and a controller for causing the heating element to heat gas held in the enclosed internal area of the vessel. The entry point or each entry port is configured to only allow gas to enter the vessel and the exit point or each exit port is configured to only allow gas to be released from the vessel.

This document claims priority from AU2023900140 entitled electrical pressure device filed on 21 Jan. 2023, the contents of which are hereby incorporated by reference in their entirety.

### TECHNICAL FIELD

The invention relates to compressor and a system and method for using the compressor for the compression of gas.

### BACKGROUND

Gas compressors are widely used in applications like refrigeration, workshops, hydrogen compression, and air conditioning.

Gas compressors come with inherent challenges. For example, many compressors are noisy which can be a nuisance. Some gas compressors are prone to wearing out and will require replacement or replacement parts which can be expensive and inconvenient. Furthermore, some compressors have pressure limitations. A compressor with pressure limitations cannot be used beyond its limits or there could be equipment failure or damage. Some compressors struggle with specific gas compositions. The materials used in the construction of such a compressor may have limitations in terms of compatibility with certain gases. Exposure to certain gases over time can lead to corrosion or degradation of the compressor components.

Many gas pressurisation systems, including those in fridges and air conditioners, rely on linear piston movement for compression. Linear piston movement involves reciprocating motion, which can result in increased wear and tear on mechanical parts. Over time, this can lead to a decrease in efficiency and reliability.

Some gas compression systems, such as Hydrogen gas compression, require a lubricant. The lubricant can assist in friction reduction and improve the seals preventing gas leaks. However, the lubricant can become a contaminant in the gas. Some diaphragm compressors can bypass this defect, but diaphragms are consumable and thus wear out over time. Moreover, such methods rely on electricity powering a normal hydraulic compressor for driving the diaphragm compressor.

Compressors can be used for pumping up tires, such as mine truck tires. However, such compressors struggle to pump the tires up to desired pressures. This is because the compressor is typically rated near the same pressure level as the pressure required in the tire resulting in inflating the tires to a desired level to take hours.

Hence, there remains a need for a compressor system that can quickly and efficiently increase gas pressure to desired levels for multiple uses. It is desirable to find an improved gas compressor which overcome or at least ameliorate some of the problems of the prior art, or which can serve as a useful alternative.

### SUMMARY OF INVENTION

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

In a first aspect there is provided a vessel for use in a compressor, the vessel comprising:
at least one wall that defines an enclosed internal area defining a fixed volume and being configured to hold a gas;
at least one entry port in the wall for introducing gas into the enclosed internal area of the vessel;
at least one exit port in the wall for releasing gas from the enclosed internal area of the vessel;
at least one heating element located in the enclosed internal area; and
a controller for causing the heating element to heat gas held in the enclosed internal area of the vessel,
wherein the or each entry port is configured to only allow gas to enter the vessel and the or each exit port is configured to only allow gas to be released from the vessel.

Also provided is a compressor system comprising:
two or more of the vessels according to the embodiments of the invention described herein, including a first vessel and a second vessel,
wherein the exit port of the first vessel is connected to the entry port of the second vessel to enable gas to flow from the first vessel into the second vessel.

Also provided is a method for increasing gas pressure, the method comprising:
introducing a gas into a first vessel of a compressor system according to the embodiments of the invention described herein,
activating the heating element in the first vessel to cause a pressure of the gas in the first vessel to increase thereby causing at least a portion of the gas to be released from the first vessel and enter the second vessel through the exit port of the first vessel and the entry port of the second vessel; and
cooling the first vessel causing additional gas to enter the first vessel via the entry port.

The compressor system can be used as a means for increasing gas pressure. In an embodiment, the compressor comprises a plurality of the vessels in fluid communication with one another arranged in series. Thus, the present disclosure concerns gas pressure increasing methods, devices, and systems which may include a series of gas pressure increasing devices connected in a series for compounding compression.

The gas can be any gas or gases that can be compressed for commercial application. The need for compressed gas(es) arises from diverse factors including storage, transportation, and process requirements. Any type of non-combustible gas can be used, but flammable gases cannot be used with a heating element in the form of an electrical resistor. The use of flammable gases in conjunction with the electrical resistors described herein may pose significant safety risks due to the potential for ignition and combustion.

The vessel sometime referred to as a compressor vessel can be any structure or container that can contain a gas. Preferably, the vessel is formed from a material that is gas tolerant and substantially gas tight. The vessel can be sealed along any joins so as to be substantially gas tight.

The vessel comprises one or more walls which can be referred to as pressure walls. The walls are made from a material that does not move or expand under pressure. The walls define an inside space within the vessel, which can be described as an enclosed internal area. The enclosed internal area can be a cavity or chamber. The enclosed internal area can have any shape. The enclosed internal area can have a fixed volume. When the pressure inside the enclosed internal area increases, since the walls do not move or expand and the internal area is of a fixed volume, the pressure inside the internal area of the vessel increases.

The fixed volume of the internal enclosed area of the vessel can be in the range of from about 400 to about 200,000 cubic centimetres, from about 600 to about 100,000 cubic centimetres, from about 1000 to about 50,000 cubic centimetres, from about 2,000 to about 10,000 cubic centimetres or from about 4,000 to about 6,000 cubic centimetres. According to an embodiment, the fixed volume of the internal enclosed area of the vessel can be greater than 200 cubic centimetres; 400 cubic centimetres; 1000 cubic centimetres; 5,000 cubic centimetres; 10,000 cubic centimetres; 20,000 cubic centimetres; 50,000 cubic centimetres; 100,000 cubic centimetres; 150,000; or 200,000 cubic centimetres. According to an embodiment, the fixed volume of the internal enclosed area of the vessel can be less than 200,000 cubic centimetres; 150,000 cubic centimetres; 100,000 cubic centimetres; 50,000 cubic centimetres; 10,000 cubic centimetres; 5,000 cubic centimetres; 1,000 cubic centimetres; 500 cubic centimetres; or 200 cubic centimetres The vessel wall thickness can be designed to withstand a particular pressure such as from about 0.5 Megapascals (Mpa) to about 300 Mpa; from about 1.0 Mpa to about 200 Mpa; from about 5.0 to about 100 Mpa. According to an embodiment the vessel wall thickness can be designed to withstand a particular pressure greater than 1.0 Mpa; 5.0 Mpa; 10 Mpa; 50 Mpa; 100 Mpa; or 200 Mpa.

Where the vessel is cylindrical there can be one wall. The wall can be capped at either end. If the vessel is cuboidal, there can be 4 walls. The 4 walls can be capped at either end. The invention is not limited to the shape or number of walls in the vessel. In embodiments, the caps can be referred to as walls.

The wall(s) can have a thickness of about 2 mm to about 6 cm. The thickness of the wall of the vessel can be increased as the volume of the enclosed internal area decreases. For example, a vessel with a smaller internal area has generally thicker walls than a vessel with a relatively larger internal area. The wall(s) can be thick enough to allow any heat generated by the gas in the internal area of the vessel to dissipate into the wall(s) of the vessel.

In an embodiment, the outer surfaces of the wall(s) have an insulation layer. Alternatively, or in addition, insulation can also be provided on an inner surface of the wall(s).

The internal linings of the wall(s) and any caps can be at least partially mirrored or coated or lined with an insulating film or partially insulating material.

In an embodiment, the pressure walls define a first internal area and inside that first internal area there is a second internal area. The second internal area can be defined by a thin wall or walls. The second internal area can comprise the gas. A coolant can be provided in the first internal area thereby surrounding the first internal area with cooling medium. The coolant can be internal to the chamber but separated from the gas by a thin wall. The thin wall can be referred to as an additional wall within the internal area of the vessel which surrounds the heating element and which creates a space between an outside of the internal wall and an inside of the vessel wall. The space being optionally filled with a coolant. Alternatively, or in addition the space is filled with insulation.

Alternatively, the pressure wall(s) of the vessel are hollow. Similar to the embodiment described above, the hollow wall(s) can provide an air gap between the gas inside the vessel and the outside environment. The enclosed internal area might benefit from cooling internal to the pressure wall(s) to combat residual heat build-up. Accordingly, there may be coolant in the hollow wall(s). In an embodiment, the hollow wall(s) comprise a first hollow wall and a second hollow wall adjacent one another. It follows that there can be two hollows in the wall(s) of the vessel. The hollow closest to the internal enclosed area can comprise a coolant. The other of the hollows can comprise air.

Accordingly, there may be insulation or partial insulation means between the gas and the chamber wall, or between the gas and any thin wall containing coolant, which thin wall might reside internal to the chamber wall.

Where there is coolant internal to the chamber of the vessel that contributes to cooling, there can be one or more ports to renew or drain the coolant as required.

In an embodiment, the present disclosure concerns a chamber of fixed volume with an inlet port and an outlet port each of which inlet port and outlet port are controlled by one-way valves. Furthermore, there is a large electrical heating resistor or element internal to the chamber of sufficient power to heat up the volume of gas and type of gas internal to the chamber.

The wall(s) of the vessel can comprise at least one entry port or inlet. The at least one entry port can be for introducing gas into the enclosed internal area of the vessel. There can be a single-entry port. There can be more than one entry port. The or each entry port is configured to only allow gas to enter the vessel. The entry port does not allow gas to exit the vessel. The or each entry port can be a one-way valve.

The entry port can receive incoming gas from the surrounding atmosphere. The entry port can receive incoming gas from a container of gas. A supply pressure into the first vessel chamber can be at any pressure.

The wall(s) of the vessel can comprise at least one exit port or outlet port. The at least one exit port can be for releasing gas from the enclosed internal area of the vessel. There can be a single exit port. There can be more than one exit port. The or each exit port is configured to only allow gas to be released from the vessel. The exit port does not allow gas to enter the vessel. The or each exit port can be a one-way valve.

The exit port can discharge into a second vessel or harvest vessel as described herein. The harvest vessel may be used to harvesting or collecting the pressurized gas.

The gas in the internal area of the vessel can be heated. The heat applied to the gas internal to the chamber can be by the use of electricity. The enclosed internal area of the vessel can have a heating element. The heating element can be an electrical heating device. The electrical heating device can be an electrical resistor. The electrical resistor can extend into the internal area of the vessel between at least a pair of conductors. The electrical resistor can be configured to substantially not touch a wall of the vessel. There can be more than one electrical resistor between more than one pair of conductors as required. The resistor can be replaced by another electrical heating device, able to periodically heat gas.

The electrical resistor can be any know material. For example, the electrical resistor can be a blend of carbon powder and a ceramic binder. The electrical resistor can be a thin film resistor comprising a thin layer of nickel-chromium or tantalum nitride deposited onto a ceramic substrate. Thick film resistors can be used which use materials like tungsten or ruthenium oxide. A wire wound resistor can be used featuring a resistive wire wound around a core, commonly made of nickel-chromium. Cermet resistors combine ceramics and metal alloys for durability. Metal oxide resistors, use metal oxide films on ceramic substrates.

The process of electrical resistance involves the hindrance of electric current by the resistor, leading to the collision of electrons with atoms within the resistor material. The resultant effect is the conversion of electrical energy into heat. Within the enclosed internal area, the generated heat transfers to the surrounding gas primarily through conduction. This conduction process is accompanied by a subsequent increase in the temperature of the surrounding gas.

A controller can be used to cause the heating element to activate and begin heating the gas held in the enclosed internal area of the vessel when first in use or after a required cooling temperature is reached and until a certain amount of pressure is reached at which point the element may be deactivated. The power applied to the electrical resistor or other electric heating device can be matched to the mass of gas to be heated.

The controller can be activated by an operator. The controller can be operated electrically or it can be operated manually. In an embodiment, the controller can be a programmable logic controller (PLC). The PLC can be programmed to activate the heating element after a required cooling temperature is reached and until a certain amount of pressure is achieved.

In a heating cycle, electricity can be applied to the electrical resistor and the gas in the internal chamber of the vessel heats up. The heating causes the gas to expand. The pressure of the gas increases inside the vessel. To any extent that the gas can, the gas moves out of the outlet port.

The outlet port of the vessel can be in fluid connection with the inlet port of a second vessel. If the outlet port is connected to a second vessel, and that second vessel has an internal gas pressure lower than the pressure inside the internal chamber when heated, gas will flow from the present vessel as described into the second vessel, increasing the pressure in that target second vessel.

The present vessel can be referred to as a first vessel. The first vessel is connected to the second vessel. The connection can be via at least one tube. There can be a third vessel connected to the second vessel, optionally by a tube(s), and so on. The vessels of a compressor system can therefore be arranged in series. Subsequent vessels connected in the series might be of different volumetric dimensions. In an embodiment the volume of the enclosed internal area of each vessel decreases as the vessels move along the series.

Following heating of the gas in the first vessel there can be a cooling cycle. In the cooling cycle, the heating applied to the gas held in the first vessel can be discontinued. The gas remaining in the first vessel can cool. The gas can be cooled by heat dissipation into and from the vessel wall(s). The cooling is optionally assisted by the coolant as described herein.

After a heating cycle, if gas did exit the chamber of the first vessel during the heating cycle, the internal pressure of the first vessel will drop. As the gas cools, the gas pressure internal to the chamber will tend towards being lower than any constant supply pressure at the entry valve, and more so as the temperature reverts towards the temperature it was before the heating cycle. The first vessel will therefore draw gas in through the entry port.

Therefore the device of an embodiment of this invention, as relates to the chamber, comprises an inlet port and an outlet port, each with one way valves, and an electrical means to periodically heat the gas internal to the chamber, forms relative to the supply pressure at the inlet port, compression at the outlet port to the extent the maximum pressure in a cycle of heating and cooling exceeds the pressure of any vessel attached to the outlet port. Therefore, this device can be described as a “pressure building device.”

A single vessel chamber or “pressure building device” can be connected to other vessels, in series, as described above. The entry port of a next vessel chamber can be connected to the outlet port of a prior vessel chamber. In the case where a next chamber is in a cooling phase and any prior chamber is in a heating phase at the same time, gas at maximum pressure in the prior chamber will tend to supply gas to the next chamber, until the point where the maximum pressure of a prior chamber does not exceed the low pressure of a next chamber.

Any vessel connected in a series of vessel might have another vessel or vessels connected to it in parallel in the normal sense as would be understood by, for example, an electrician.

There can be any number of vessels in fluid communication with one another in a connected series. There can be at least 2, 4, 6 or 8 vessels arranged in series. In the case of 8 of these chambers connected in series, where each of the chambers or “pressure building devices” are configured to double the inlet pressure at the outlet on heating, and where for example a computer might control the heating cycles and cooling cycles of each chamber to best advantage, the compounded pressure at the last chamber outlet would max out close to 256 times the pressure at the first chamber inlet.

In the case the pressure in each chamber is configured to triple, which might for example require a temperature of approximately 1000 degrees C. for a short time in each chamber, in that case the pressure in the final chamber would tend towards a 6561-fold increase, given time.

The compressed gas can ultimately be collected or harvested in a collection chamber. The collection chamber can be any vessel that requires compressed gas. The collection chamber can be the hydrogen tank in a vehicle, or a stationary tank in a residence or a holding tank in a workshop or any other thing requiring compressed gas.

### BRIEF DESCRIPTION OF THE FIGURES

The accompanying drawings described herein are used to enable further understanding of the present disclosure and constitute a part of the present disclosure. The example embodiments of the present disclosure and the description of the example embodiments are used to illustrate the present disclosure, and do not constitute any limitation to the present disclosure. In the drawings:

FIG. 1 shows the construction of a vessel having a chamber and control means, without showing the valves and ports.

FIG. 2 shows two vessels, each with an entry port and an exit port, one-way valves, an ambient pressure source and a target vessel to receive compressed gas.

FIG. 3 shows a non-ambient pressure source of gas, three vessels connected in series and a target vessel to receive the compressed gas with an outlet.

FIG. 4 depicts a vessel, without showing the valves and ports, but including a means for cooling internal to the pressure walls.

FIG. 5 is a simple schematic depicting how “pressure building devices” or vessels or chambers can be connected together in series for “compounding compression”.

FIG. 6 is a further schematic following on from FIG. 5, depicting in simplified form, how the system might sequentially compress any gas that is impervious to ignition, from 1 MPa to 243 MPa.

### DETAILED DESCRIPTION OF EMBODIMENTS OF THE INVENTION

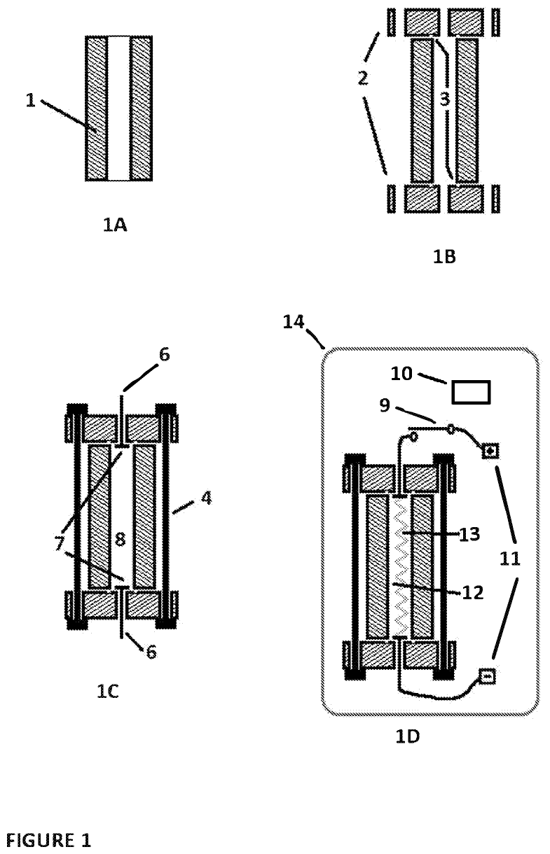

FIG. 1 is an embodiment of a device 14 having walls 1 and caps 2, wherein wall 1 is a cylinder defining an enclosed internal area or cavity 8, and caps 2 securing both ends of the cylinder. The cylinder can be held together by fasteners 4. The entire vessel chamber can be sealed by O-rings (not shown). The O-rings can be located in O-ring slots 3.

Insulator 6 is arranged in the cap 2 to hold conductor 7 into the internal area of the vessel. There is one insulator 6 with a conductor 7 at each end of the cylindrical device 14. Further to this there is an electrical resistor 13, internal to the cavity 8. The resistor 13 is attached to both conductors 7. An electrical power supply, either Ac or Dc type, can periodically supply power to the resistor 13, by means of control 10 and switch 9.

The device of FIG. 1 is capable of heating a gas 12 which resides inside cavity 8. The application of electrical power can increase the temperature of gas 12. The ceasing of the aforementioned heating results in a lowering of the temperature of gas 12 because at least some of the heat can escape into the walls 1, and eventually to the ambient atmosphere, over time.

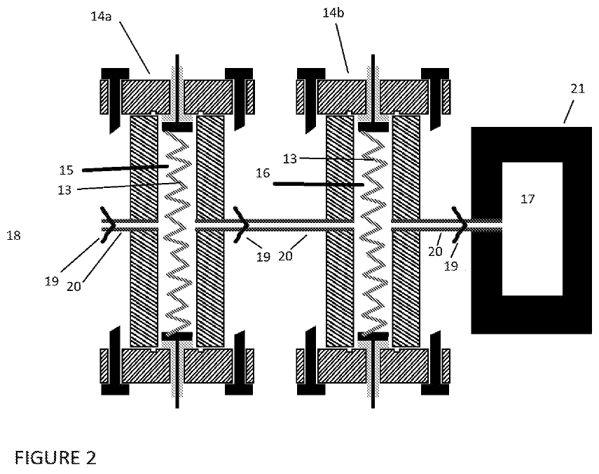

FIG. 2 shows a pair of vessels 14a, 14b in fluid communication with one another. Each of device has an intake (or entry) port and an outlet (or exit) port. One-way valves 19 define each of the ports. There is tubing 20 forming or attached to each port. The entry port of device 14a is connected to ambient gas supply 18. The entry port 19 of device 14b is the exit port of device 14a. The exit port of device 14b leads to target vessel 21 which comprises gas 17.

In FIG. 2, there is shown a shared one-way valve between devices 14a and 14b. Alternatively each entry and exit port can have its own one-way valve.

In a first movement, resistor 13 is supplied with current. The resistor heats up and in turn heats up gas 15 in device 14a. The pressure of gas 15 inside device 14a increases. The pressure of the gas 15 eventually exceeds the pressure of gas 16 in device 14b. Accordingly, the gas 15 will flow through the one-way valve 19 out of device 14a and into the device 14b. During this first movement, the resistor 13 in device 14b is turned on. The gas pressure inside 14b is thereby raised.

In a second movement, the resistor inside 14a is turned off and the gas 15 reverts over time to its original temperature. There is less gas 15 inside device 14a than there was before the first movement. As the gas 15 cools, more gas is drawn into device 14a from supply 18, by nature of the one-way valve.

In a third movement, the resistor of device 14b is turned on and gas 16 increases in pressure. As the gas 16 increases in temperature and expands, some gas passes via the exit from device 14b to vessel 21.

By controlled heating and cooling of gases 15 and 16 in devices 14a and 14 b, gas is drawn into 14 a from 18 and gas passes from 15 to 16, and gas passes from 16 to 17. Therefore, the devices 14 a and 14 b, together with ports and one-way valves, are able to cumulatively compress gas 18 into a vessel 21, until such time as the pressure of gas 17 equals the maximum pressure in device 14b, and the minimum pressure in device 14b equals the maximum pressure in device 14a, and the minimum pressure in device 14a equals the pressure of gas 18.

In an embodiment, multiple devices 14a feed gas into device 14b. In this example, source of gas 18 is at ambient pressure. However, any source of gas at any pressure could replace gas 18. Any device or container could replace vessel 21.

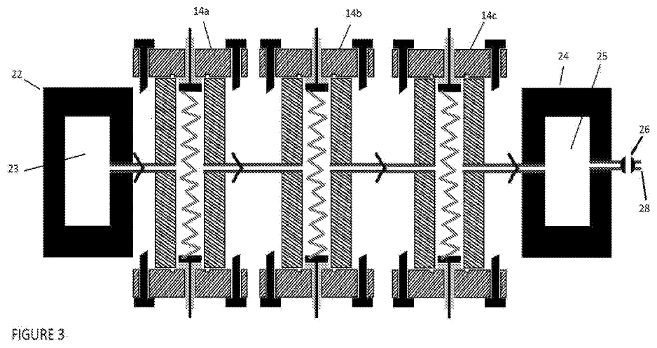

FIG. 3 shows three vessels in fluid communication with one another and a collection vessel 24. Any number of devices 14 can be used in series. In this embodiment, the source of gas 23 for the first vessel resides inside pressure vessel 22. The gas 23 can be delivered under any pressure including elevated pressure compared to standard pressure. The vessels holding gas, the conduits 20 between the devices can all withstand the pressures involved.

FIG. 3 shows a tap 26 on pipe 28 allowing for a pressure discharge of the gas 25 inside of vessel 24. Any discharge at tap 26 might be a trigger for the multitude of devices 14a, 14b, and 14c to start work. Upon initiation, gas 23 can be pulled from vessel 22 and compressed through the series of devices 14a-14c.

In an embodiment, vessel 22 may supply hydrogen to device 14a. For example, according to an embodiment vessel 22 may be an electrolyser operating on the principle of electrolysis-a process where an electric current is passed through a water causing the water molecules to dissociate into hydrogen (H₂) and oxygen (O₂). Vessel 22 would then only supply hydrogen into device 14a.

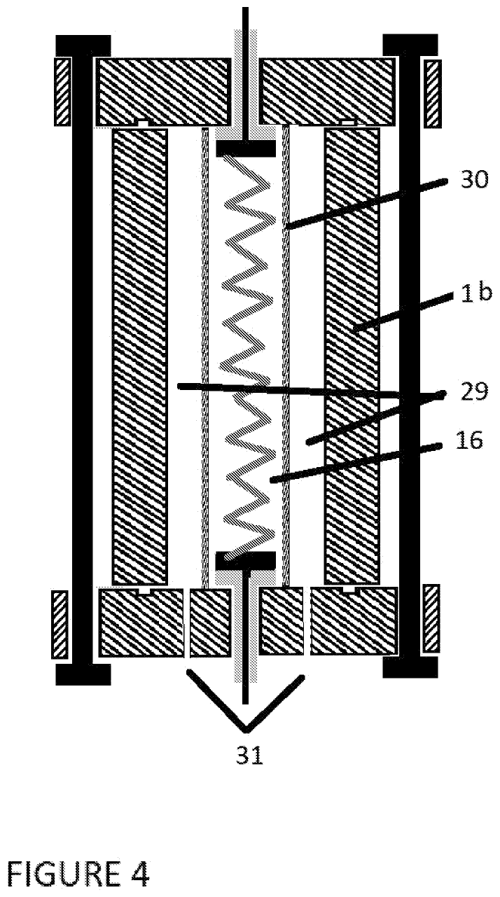

FIG. 4 shows how a thin wall or containment 30 can be used to define a second internal area inside the device 14. FIG. 4 is missing some components since it is intended to simply show an embodiment of how to remove residual heat from the vessel. The second internal area is located inside the first internal area or cavity 8 between for example outer pressure walls 1b and internal gas 16. Liquid coolant 29 can be located in the second internal area to cool gas 16 through the thin walls 30.

Coolant 29 can remove residual heat from the system through ports 31. It is understood that the coolant must be kept at substantially the same pressure as the gas 16. Any known pressure adjusting method can be used to compensate or alleviate substantial or minor pressure differences between the gas 16 internal to walls 30 and the liquid coolant 29 external to walls 30.

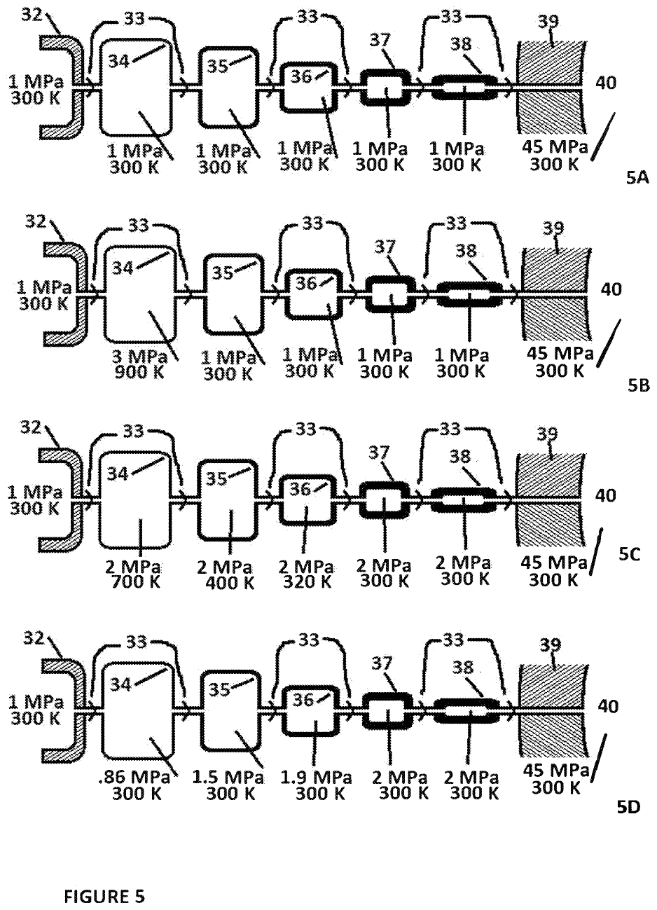

FIG. 5 is a schematic of five “pressure building devices” or vessels 34, 35, 36, 37, 38 in fluid communication with one another. The flow of gas between starting vessel (or containment vessel) 32 and “pressure building devices” 34, 35, 36, 37, 38 and target vessel 39 is left to right. The Figure depicts a progression from top to bottom along A to D.

A one-way valve 33 resides at each side of each “pressure building device”. The five vessels 34, 35, 36, 37, 38 are shown in cross-section. The sizes of the “pressure building devices” are all different, but any size can be used.

In this schematic, the wall thicknesses of each of the “pressure building devices” are different according to need, dictated by position in the series, source pressure from vessel 32, degree of heating and various other factors. For example, as each next pressure building device in a series of such devices will have to allow for a greater low pressure and high pressure, than a previous pressure building device in the series, it is understood that the outer wall or pressure wall of any next pressure building device may be thicker than the walls of any prior pressure device in the series in the case the chambers are of the same internal size and shape. This can be negated for the most part where the next pressure building device is substantially smaller in all aspects/dimensions.

In FIG. 5, the walls of the target pressure vessel 39 which collects the compressed gas are thick. The wall of vessel 39 represent a relatively large tank whose initial pressure is e.g. 45 MPa representing, for example, a half full hydrogen tank which might belong to e.g. a vehicle. The target pressure vessel 39 holds pressure 45 MPa by way of the one-way valve 33 immediately to its left, between target vessel 39 and Pressure building device 38.

In this embodiment, there are infinite sources of gas from containment vessel or device 32. The source of gas is shown at 1 MPa and at a nominal temperature of about 330 Kelvin.

The pressure from vessel 32 has been distributed into vessels 34 through to 38, all at 1 Mpa. As can be seen in FIG. 5B, the temperature in vessel 34 has increased from 330K in FIG. 5A to 900K in FIG. 5B. The temperature increase from 300K to 900K is a result of the herein described electrical heating. The instantaneous effect of the heating is that the pressure inside vessel 34 has raised 3-fold (from 1 MPa to 3 MPa) in accordance with the gas laws, confined space and increased temperature.

In FIG. 5C, it can be seen that the one-way valves 33 between 34, 35, 36, 37 and 38 have allowed the equalization of the increased pressure between the “pressure building devices”. The one-way valve 33 between vessels 32 and 34 have prevented gas from moving back into starting vessel 32. Furthermore, no gas has moved between vessels 38 and 39 because the gas 40 inside vessel 39 is at a higher pressure.

In FIG. 5D, it can be seen that upon removing heating from the gas inside vessel 34, the gas has reverted back to a temperature of 300K. This shrinking of the reduced amount of gas reduces the pressure in vessel 34 to 0.86 MPa. The partially heated gas in vessel 35 has also reverted to a pressure of 1.5 MPa upon cooling. The gas inside vessel 36 has changed to a pressure of 1.9 MPa. Each of “pressure building devices” 37 and 38 substantially keep the pressure 2 MPa.

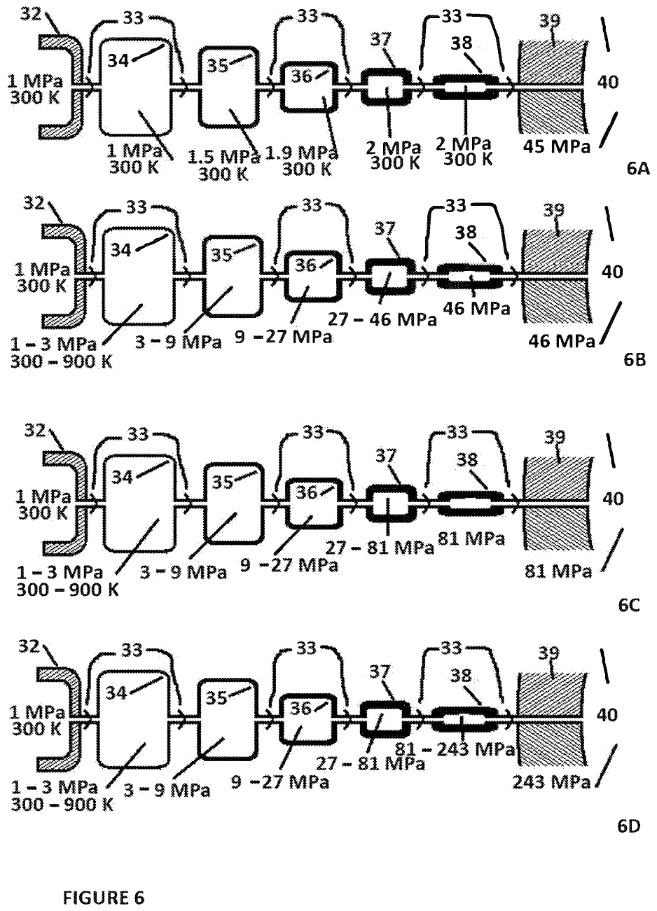

FIG. 6 is a progression from FIG. 5. In FIG. 6A the gas in vessel 32 primes the “pressure building device” 34 back up to 1 MPa. As shown in FIG. 6B, the pressure inside “pressure building device” 34 fluctuates between 1 MPa in the cooling phase and 3 MPa in heating phase. In this case, in a similar manner to how vessel 32 is a source of 1 MPa pressure to “pressure building device” 34, “pressure building device” 34 is an occasional source of up to 3 MPa pressure to “pressure building device” 35.

The heating of each device and the subsequent cooling is controlled by the controller controlling the heating element. The timing of the heating and cooling cycle can be controlled by computer or other means. For example, “Pressure building device” 35 can be allowed to cool down at the same time as “pressure building device” 34 is heating up. “Pressure building device” 35 has an internal pressure ranging between a nominal 3 MPa and 9 MPa.

“Pressure building device” 35 can be a source of inlet pressure for “pressure building device” 36 at up to 9 MPa.

It should be clear from FIG. 6 how each “pressure building device” further along the series can be the recipient of pressure up to the maximum pressure achieved in the preceding “pressure building device”, and how it can be a source of increased gas pressure delivered to the next “pressure building device” in the series.

In FIG. 6D, a nominal final pressure in the target vessel 39 is provided of 243 MPa. The pressures and temperatures of the progression in FIGS. 5 and 6 are exemplary only. To approach those pressures may necessitate many thousands of cycles of the process described with the “pressure building devices.” Any number of “pressure building devices” can be linked in series to achieve a pressure goal and in an attempt to overcome pressure losses.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Any promises made in the present description should be understood to relate to some embodiments of the invention and are not intended to be promises made about the invention. Where there are promises that are deemed to apply to all embodiments of the invention, the right is reserved to later delete those promises from the description since there is no intention to rely on those promises for the acceptance or subsequent grant of a patent unless the context makes clear otherwise.

1. A vessel for use in a compressor, the vessel comprising:
at least one first wall that defines an enclosed first internal area defining a fixed volume;
at least one second wall that at least partially defines an enclosed second internal area located in the enclosed first internal area, the enclosed second internal area being configured to hold a gas;
at least one entry port in the at least one first wall for introducing gas into the enclosed second internal area of the vessel;
at least one exit port in the at least one first wall for releasing gas from the enclosed second internal area of the vessel;
at least one heating element located in the enclosed second internal area;
an insulation layer lining an inner surface of the at least one first wall; and
a controller for causing the at least one heating element to heat gas held in the enclosed second internal area of the vessel, and
wherein the or each entry port is configured to only allow gas to enter the vessel and the or each exit port is configured to only allow gas to be released from the vessel.

2. (canceled)

3. The vessel according to claim 1, wherein the at least one entry port that allows gas to enter the enclosed second internal area of the vessel as internal pressure of the enclosed second internal area of the vessel decreases.

4. The vessel according to claim 1, wherein the at least one exit port allows gas to be released as internal pressure of the enclosed second internal area of the vessel increases.

5. The vessel according to claim 1, wherein the enclosed first internal area is defined by a cylindrical wall with openings at either end with each opening being sealed by a respective cap.

6. The vessel according to claim 1, wherein there is a space between an outside of the at least one second wall and an inside of the at least one wall.

7. The vessel according to claim 6, wherein the vessel includes liquid coolant, insulation, or both in the space.

8. A compressor system comprising:
two or more of the vessels according to claim 1, including a first vessel and a second vessel, wherein one of the at least one exit port of the first vessel is connected to one of the at least one entry port of the second vessel to enable gas to flow from the first vessel into the second vessel.

9. The compressor system according to claim 8, further comprising a third vessel wherein one of the at least one exit port of the second vessel is connected to one of the at least one entry port of the third vessel to enable gas to flow from the first vessel into the third vessel via the second vessel.

10. A method for increasing gas pressure, the method comprising:
introducing a gas into a first vessel of a compressor system according to claim 8,
activating the at least one heating element in the first vessel to cause a pressure of the gas in the first vessel to increase thereby causing at least a portion of the gas to be released from the first vessel and enter the second vessel through the at least one exit port of the first vessel and the at least one entry port of the second vessel; and
cooling the first vessel causing additional gas to enter the first vessel via the at least one entry port.

11. The method according to claim 10, wherein the system includes a third vessel connected to the at least one exit port of the second vessel and the method further includes:
activating the at least one heating element in the second vessel to cause a pressure of the gas to increase thereby causing at least a portion of the gas to be released from the second vessel and enter the third vessel through the at least one exit port of the second vessel and the at least one entry port of the third vessel.

12. The method according to claim 10, wherein the gas is hydrogen.

13. The method according to claim 11, further comprising cooling the second vessel after the gas has been released from the second vessel and entered the third vessel.

14. The method according to claim 13, further comprising heating the first vessel after or while the second vessel is cooled causing gas to be released from the first vessel and enter the second vessel.

15. The method according to claim 11, further comprising cooling the third vessel to reduce the temperature of the gas.

16. The method according to claim 11, further comprising harvesting the gas released from the third vessel.

17. A method for increasing gas pressure, the method comprising:
introducing a gas into the vessel according to claim 1,
activating the at least one heating element to cause a pressure of the gas to increase thereby causing at least a portion of the gas to be released via the at least one exit port of the vessel; and
cooling the vessel causing additional gas to enter the vessel via the at least one entry port due to a drop in pressure.

18. The method according to claim 17, further comprising harvesting the released gas.
